(19) United States
(12) Patent Application Publication
(10) Pub. No.: US 2016/0121883 A1
(43) Pub. Date: May 5, 2016

(54) FRONT-REAR TORQUE SPLIT CONTROL FOR AN ALL-WHEEL-DRIVE VEHICLE WITH INDEPENDENT POWER-SOURCES

(71) Applicant: GM GLOBAL TECHNOLOGY OPERATIONS LLC, Detroit, MI (US)

(72) Inventors: Xiaofeng Mao, Novi, MI (US); Thomas A. Klingler, Lake Orion, MI (US); Eric E. Krueger, Chelsea, MI (US)

(21) Appl. No.: 14/533,142

(22) Filed: Nov. 5, 2014

(51) Int. Cl. B60W 30/02; B60W 10/119; B60W 10/06; B60W 10/08; B60K 17/356; B60W 20/00

(52) U.S. Cl. CPC B60W 30/02; B60K 17/356; B60W 20/108; B60W 10/06; B60W 10/08; B60W 10/119; B60W 2520/10; B60W 2520/105; B60W 2520/14; B60W 2520/26; B60W 2520/28; B60W 2540/18; B60W 2720/26; Y10S 903/93

(57) ABSTRACT

A method of controlling operation of an all-wheel-drive vehicle having independent power-sources includes driving the vehicle via at least one of a first power-source through a first set of wheels and a second power-source through a second set of wheels. The method also includes determining a rotating speed of each of the first and second sets of wheels relative to a road surface. The method additionally includes determining a road speed of the vehicle and determining a longitudinal acceleration of the vehicle. The method also includes determining a slip of the vehicle relative to the road surface using the determined rotating speed of each of the first and second sets of wheels and the speed of the vehicle. Furthermore, the method includes controlling the vehicle slip via regulating a torque output of the first and/or second power-source.

### TECHNICAL FIELD

The disclosure relates to a system and a method for controlling front to rear torque split in an all-wheel-drive vehicle that has independent power-sources for each of the front and rear axles.

### BACKGROUND

Modern vehicles are typically configured as either two- or all-wheel-drive. Either type of a vehicle may employ a conventional powertrain, where a single engine is used to propel the vehicle, or a hybrid powertrain, where two or more distinct power sources, such as an internal combustion engine and an electric motor, are used to accomplish the same task. Furthermore, a multi-speed automatically-shiftable transmission may be employed as part of either type of powertrain, and may thus be used in a hybrid vehicle with all-wheel-drive.

In order to maximize fuel efficiency of a hybrid powertrain, the vehicle's engine may be shut off when engine torque is not required for driving the vehicle. Such a situation may be encountered when the hybrid vehicle is maintaining a steady cruising speed, is in a coast down mode, i.e., when the vehicle is decelerating from elevated speeds, or is stopped.

An all-wheel-drive hybrid vehicle may be configured as an axle-split vehicle. In such a vehicle, independent power-sources, such as an engine and an electric motor, are set up to independently power individual vehicle axles that are operatively connected to the respective power-sources, thus generating on-demand all-wheel-drive propulsion. In such an axle-split hybrid vehicle employing an engine and an electric motor, the electric motor may be capable of propelling the vehicle while the transmission is in neutral and the engine is shut off. Similar to vehicles with conventional powertrains, such all-wheel-drive hybrid vehicles may experience traction loss at one or more of their driven wheels. Such traction loss may be a result of driving demands of the vehicle's operator and/or road conditions.

### SUMMARY

A method of controlling operation of an all-wheel-drive vehicle having independent power-sources is provided. The method includes driving the vehicle via at least one of a first power-source through a first set of wheels and a second power-source through a second set of wheels. The method also includes driving the vehicle relative to a road surface via at least one of the first power-source and the second power-source. The method additionally includes determining a rotating speed of each of the first and second sets of wheels relative to the road surface. The method also includes determining a speed of the vehicle relative to the road surface and determining a longitudinal acceleration of the vehicle.

The method additionally includes determining a slip of the vehicle relative to the road surface at the first and/or second sets of wheels using the determined rotating speed of each of the first and second sets of wheels and the speed of the vehicle. Furthermore, the method includes controlling the slip of the vehicle relative to the road surface via regulating a torque output of the at least one of the first power-source and the second power-source. Accordingly, controlling the slip of the vehicle includes regulating or varying an amount of slip of at least one of the first and second sets of wheels relative to the road surface.

The vehicle may include a steering wheel. A direction of the vehicle is controlled via an input at the steering wheel that generates a steering wheel angle. In such a case, the method may also include determining the steering wheel angle and a yaw rate of the vehicle. Additionally, controlling the slip of the vehicle relative to the road surface may include using the determined steering wheel angle and yaw rate to control the yaw rate of the vehicle

Each of the first and second sets of wheels may include a first-side drive wheel and a second-side drive wheel, which may be a left- and a right-side wheel, respectively, for transmitting the drive torque to the road surface. In such a case, the act of determining the rotating speed of each of the first and second sets of wheels relative to the road surface may include determining the rotating speed of each respective drive wheel.

The vehicle may include an electronic limited slip differential (eLSD) operatively connected to one of the first power-source and the second power-source and configured to apportion the drive torque between the first-side and second-side drive wheels. In such a case, the method may additionally include regulating the eLSD to vary the torque output of the at least one of the first power-source and the second power-source between the first-side and second-side drive wheels to control the yaw rate of the vehicle.

The vehicle may include a controller, and each of the acts of regulating the torque output of the at least one of the first power-source and the second power-source and regulating the eLSD may be accomplished via such a controller. Such a vehicle-based controller may also be configured to determine the rotating speed of each of the first and second sets of wheels relative to the road surface, the speed of the vehicle relative to the road surface, and the longitudinal acceleration of the vehicle with the aid of appropriate sensors.

The act of regulating the torque output of the at least one of the first power-source and the second power-source may include arbitrating a torque split between the first and second sets of wheels via the controller to thereby control the yaw rate of the vehicle or generate a desired yaw rate.

The act of controlling the slip of the vehicle relative to the road surface may be accomplished in a feed-forward or predictive loop via comparing the determined steering wheel angle, yaw rate, and a difference between the rotating speeds of each of the first and second sets of wheels and the speed of the vehicle with predetermined respective values for the steering wheel angle, the yaw rate, the difference between the rotating speeds of each of the first and second sets of wheels, and the speed of the vehicle in a look-up table programmed into the controller.

The act of controlling the slip of the vehicle relative to the road surface may be accomplished in a feed-back or closed loop via determining an amount or severity of wheel spin at each of the first and second sets of wheels and regulating the torque output of the first power-source and the second power-source to control the amount of wheel spin at the respective first and second sets of wheels.

The act of determining the speed of the vehicle relative to the road surface may include receiving via the controller from an earth-orbiting satellite a signal indicative of the speed of the vehicle.

The method may additionally include driving the vehicle in an “electric vehicle” or EV mode solely by the second power-source while the first power-source is off and starting the first power-source for controlling the slip of the vehicle relative to the road surface. As employed herein, the EV mode is a mode where the vehicle is powered solely via the second power-source while the first power-source is shut off and the first power-source is operatively disconnected from the first set of wheels.

The method may also include phasing out the second power-source via the controller while the first power-source is being controlled to generate the desired level of output torque in the first power-source-only drive mode. The vehicle may include an energy storage device configured to supply energy to the second power-source. In such a case, the act of phasing out the second power-source may be accomplished when the energy supplied to the second power-source by the energy storage device is below a predetermined value.

A system for controlling operation of such a vehicle is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic illustration of an electric all-wheel-drive hybrid vehicle.

FIG. 2 schematically illustrates, in flow chart format, a method of controlling operation of the electric all-wheel-drive hybrid vehicle shown in FIG. 1.

### DETAILED DESCRIPTION

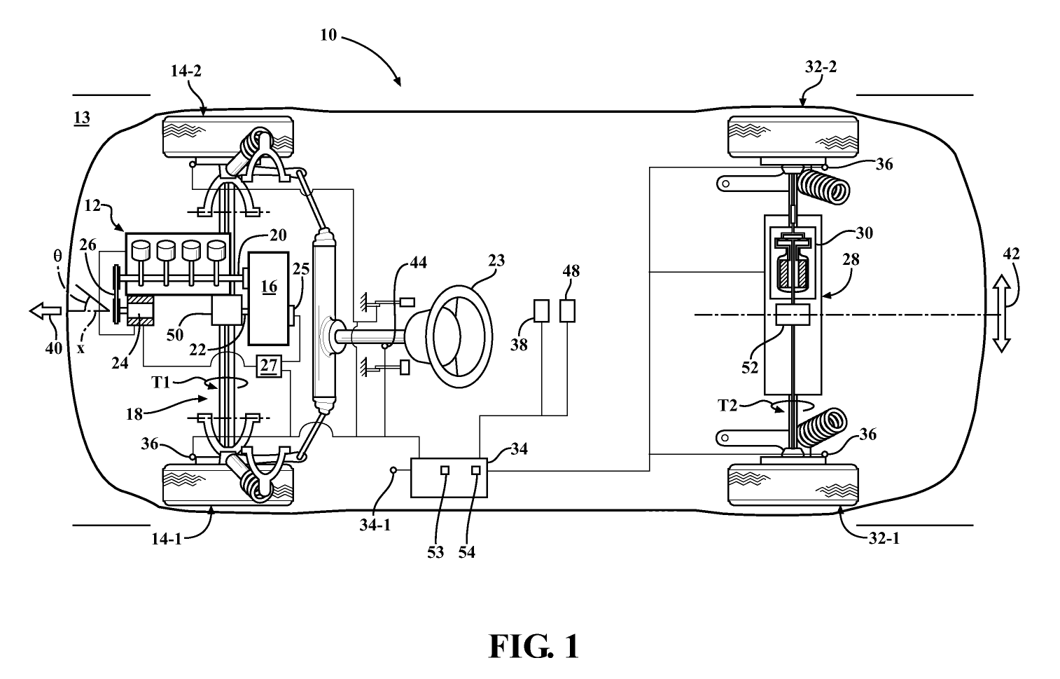

Referring to the drawings in which like elements are identified with identical numerals throughout, FIG. 1 illustrates a vehicle 10 having independent first and second power-sources that are operatively connected to respective sets of driven wheels in order to provide on-demand all-wheel-drive propulsion. The vehicle 10 includes a first power-source shown as an internal combustion engine 12 configured to drive the vehicle via a first set of wheels 14, which includes a first or left-side wheel 14-1 and a second or right-side wheel 14-2, for transmitting engine output torque T1 to a road surface 13 through a transmission 16 and a first axle 18. As contemplated herein, the transmission 16 may be a multi-speed automatically-shiftable transmission that utilizes a gear train and multiple torque transmitting devices to generate discrete gear ratios between an input 20 and an output 22 of the transmission, or a continuously variable transmission (CVT). The vehicle 10 also includes a steering wheel 23 configured to control a direction of the vehicle via turning the first set of wheels 14 through an input of a specific steering wheel angle.

The vehicle 10 also includes a second power-source shown as a first motor-generator 24. In the example embodiment, the first motor-generator 24 may be configured as an integrated starter-generator (ISG) or a 12 volt stop-start motor. The ISG contemplated herein is a 36 volt or greater motor-generator that is connected directly to the engine 12 via a belt 26 and receives its electrical energy from an energy storage device 27, such as one or more batteries. As shown, the first motor-generator 24 is used for quickly starting and spinning the engine 12 up to operating speeds as part of an engine stop-start arrangement. Additionally, the first motor-generator 24 may be used for generating electrical energy for use by accessories (not shown) of the vehicle 10, such as power steering and a heating ventilation and air conditioning (HVAC) system. As shown in FIG. 1, the energy storage device 27 also provides electrical power to operate an auxiliary fluid pump 25 to apply the torque transmitting devices in preparation for the engine 12 to be restarted by the first motor-generator 24.

The vehicle 10 additionally includes a second axle 28. The second axle 28 is operatively independent from the engine 12, the transmission 16, and the first motor-generator 24. The second axle 28 includes a second motor-generator 30 that is configured to drive the vehicle 10 via a second set of wheels 32, which includes a first or left-side wheel 32-1 and a second or right-side wheel 32-2. The second motor-generator 30 receives its electrical energy from the energy storage device 27. Accordingly, the second motor-generator 30 is configured to drive the vehicle 10 via motor-generator output torque T2 independently from the engine 12 and provides the vehicle 10 with an on-demand electric axle drive. The driving of vehicle 10 solely via the second motor-generator 30 results in the vehicle being operated in a purely electric vehicle or “EV” mode. Furthermore, when both first and second axles 18, 28 are driven by their respective power sources, the engine 12 and the second motor-generator 30, the vehicle 10 is endowed with all-wheel-drive. Generally, the electric all-wheel-drive system of the vehicle 10 with its attendant first and second axles 18, 28 is arranged longitudinally along a vehicle axis X. Accordingly, the vehicle 10 includes on-demand all-wheel-drive propulsion that may be provided via the independently operating engine 12 and second motor-generator 30. Although the remainder of the disclosure specifically describes the vehicle 10 using the engine 12 and the second motor-generator 30, the vehicle 10 is not limited to such specific independent first and second power-sources.

During operation, the vehicle 10 may be driven solely by the second motor-generator 30 while the engine 12 is shut off and the transmission 16 is placed in neutral in order to conserve fuel and improve the vehicle's operating efficiency. The engine 12 may, for example, be shut off when the vehicle 10 is maintaining a steady cruising speed which may be sustained solely by the torque output T2 of the second motor-generator 30. Additionally, the engine 12 may be shut off when the vehicle 10 is in a coast down mode, i.e., when the vehicle is decelerating from elevated speeds, or when the vehicle is stopped. In a situation when the vehicle 10 is maintaining a steady cruising speed, the engine 12 may at any moment be restarted to participate in driving the vehicle. In order to participate in driving the vehicle 10, the engine 12 will be called upon to generate an appropriate level of engine torque that will result in a desired level of transmission output torque, i.e., transmission torque at the output 22.

The desired level of transmission output torque may be representative of whether the vehicle 10 is to be driven in an electric all-wheel-drive mode or in an engine-only drive mode. When the vehicle 10 is to be driven in the electric all-wheel-drive mode after the engine restart, the desired level of torque is determined in response to a request generated by the vehicle's operator. A situation may develop when the vehicle 10 experiences traction loss at one or more of the drive wheels, which may take place in the first set of wheels 14 and/or the second set of wheels 32. Such traction loss may be a result of driving demands of the vehicle's operator, such as rapid acceleration from a stop or powering around a turn, which may cause an unloading and slipping of an inside wheel, and/or road conditions, such as inclement weather or a loose road surface 13. Accordingly, having drive torque simultaneously transmitted to both first and second sets of wheels 14, 32 may be advantageous for meeting demands of the operator. Additionally, when the vehicle 10 is to be driven in the engine-only drive mode, the second motor-generator 30 may need to be phased out as the engine 12 is being phased in. Such a situation may develop when the energy supplied to the second motor-generator 30 by the storage device 27 is below a predetermined threshold value that is sufficient to operate the second motor-generator.

The vehicle 10 also includes a controller 34 that is responsible for accomplishing the flying start of the engine 12 and phasing in of engine torque for driving the vehicle. As envisioned herein, the controller 34 may be an electronic control unit (ECU) that is employed to regulate and coordinate the hybrid propulsion of the vehicle 10 which includes the operation of the engine 12, the transmission 16, and the first and second motor-generators 24, 30. The controller 34 is configured to receive a request for the engine 12 to be started when the vehicle 10 is being driven solely via the second motor-generator 30. The controller 34 is also configured to control the engine 12 to generate the desired level of transmission output torque according to whether the vehicle 10 is to be driven in the electric all-wheel-drive mode or in the engine-only drive mode. Additionally, the controller 34 may be programmed to control the application of fluid pressure required to lock-up individual torque transmitting devices inside the transmission 16 in order to place the transmission into a particular gear ratio.

The controller 34 may also be programmed to determine a desired engine speed and a gear ratio in the transmission 16 according to the desired level of transmission output torque. For example, the desired speed of the engine 12 and the appropriate gear ratio in the transmission 16 may be selected from a table of mapped data that was gathered during testing and development of the vehicle 10. Such a table of mapped data may also be programmed into the controller 34 in order for the desired level of transmission output torque to be cross-referenced by the controller against the torque curve of the engine 12, allowable engine speeds, and transmission gear ratios at the present speed of the vehicle 10. Accordingly, the controller 34 may then select the most efficient combination of gear ratio, engine speed, and engine fueling to generate the desired level of transmission output torque for driving the vehicle 10 in response to the received request for the engine 12 to be restarted.

The controller 34 is configured or programmed to determine in real-time rotating speeds of each of the first set of wheels 14, including individual rotating speeds of the left- and right-side wheels 14-1, 14-2, and of the second set of wheels 32, including individual rotating speeds of the left- and right-side wheels 32-1, 32-2, relative to the road surface 13 when the vehicle 10 is being driven via at least one of the engine 12 and the second motor-generator 30. The rotating speed of each side wheel 14-1, 14-2, 32-1, and 32-2 may be sensed via appropriate individual sensors 36 positioned at the respective wheels and communicated to the controller 34 for signal processing. The controller 34 is also programmed to determine a speed of the vehicle 10 relative to the road surface 13, as well as longitudinal acceleration of the vehicle, i.e., acceleration in the direction along the vehicle axis X. The controller 34 may estimate the speed of the vehicle 10 by using the sensed rotating speeds of the side wheels 14-1, 14-2, 32-1, and 32-2. Alternatively, the controller 34 may be configured to receive via an antenna 34-1 a signal from an earth-orbiting satellite (not shown), wherein the signal would provide a more precise determination of the speed of the vehicle 10. The longitudinal acceleration of the vehicle 10 may be sensed and communicated to the controller 34 by an accelerometer 38 positioned on the vehicle 10.

The controller 34 is also programmed to determine a slip of the vehicle 10 relative to the road surface 13. The slip of the vehicle 10 may include a measure of how much the first and second sets of wheels 14, 32 have slipped in a longitudinal direction 40, i.e., in the direction along the vehicle axis X. Specifically, the slip of the vehicle 10 in the longitudinal direction 40 may include a measure of how much any individual side wheel 14-1, 14-2, 32-1, and 32-2 has slipped longitudinally, as identified by the discrepancy between the determined speed of the vehicle and the corresponding rotating speed of each particular wheel. The slip of the vehicle 10 may also include a measure of how much any of the side wheels 14-1, 14-2, 32-1, and 32-2 have slipped a transverse direction 42, i.e., in a direction generally perpendicular to the vehicle axis X, which identifies that the vehicle has deviated from its intended direction or path along the road surface 13. The intended direction of the vehicle 10 may be identified by the steering wheel angle, which can be detected by a sensor 44 operatively connected to the steering wheel 23 and communicated to the controller 34.

The controller 34 is additionally programmed to control the slip of the vehicle 10 relative to the road surface 13 via regulating at least one of the respective torque outputs T1 and T2 of the engine 12 and the second motor-generator 30. In accordance with a foregoing description, controlling the slip of the vehicle 10 includes controlling an amount of slip of at least one of the first and second sets of wheels 14, 32 relative to the road surface 13. As noted above, such slip of the first and second sets of wheels 14, 32 may occur relative to the road surface 13 in the longitudinal direction 40. For example, such a situation may develop when drive torque of either the engine 12 or the second motor-generator 30 overcomes the grip of the respective sets of 14, 32 while the vehicle 12 is generally heading in the longitudinal direction 40. As also noted above, slip of the first and second sets of wheels 14, 32 may occur relative to the road surface 13 in the transverse direction 42 generally perpendicular to the vehicle axis X, for example during cornering of the vehicle 10. Slip of either the first set of wheels 14 or the second sets of wheels 32 in the transverse direction 42 sets up a yaw rotation of the vehicle 10 and changes the direction the vehicle is pointing—to the left or to the right of the longitudinal direction 40. As understood by those skilled in the art, a yaw rate of the vehicle 10 is the angular velocity of the yaw rotation, i.e., the rate of change of a heading angle θ, which may be detected via a yaw rate sensor 48 positioned on the vehicle 10.

To control the slip of the vehicle 10 relative to the road surface 13, the controller 34 may be configured to determine the steering wheel angle and a yaw rate of the vehicle via communication with the respective steering wheel angle sensor 44 and yaw rate sensor 48. Furthermore, the controller 34 may be programmed to compare the determined steering wheel angle and yaw rate and regulate the respective torque output T1 from the engine 12 and the second motor-generator 30 to control the yaw rate of the vehicle 10. Such control of the yaw rate of the vehicle 10 is intended to return actual vehicle heading to the desired heading being commanded by the operator at the steering wheel 23, which is generally closer to the longitudinal direction 40.

An increase in torque output T1 from the engine 12 will tend to generate “understeer”, or cause the vehicle 10 to steer less than the amount commanded by the operator at the steering wheel 23. On the other hand, an increase in torque output T2 from the second motor-generator 30 will tend to generate “oversteer”, or cause the vehicle 10 to steer more than the amount commanded by the operator at the steering wheel 23. Accordingly, varying the respective torque outputs T1, T2 of the engine 12 and the second motor-generator 30 will adjust the attitude of the vehicle 10, depending on whether understeer or oversteer is needed to change the heading angle θ, and bring the vehicle back in line with the desired vehicle heading commanded at the steering wheel 23. In order to adjust the attitude of the vehicle 10, the controller 34 may additionally be configured to arbitrate, i.e., assess, coordinate, and regulate, an appropriate torque split between the first and second sets of wheels 14, 32. Such a torque split between the first and second sets of wheels 14, 32 will generally be arbitrated for the most efficient propulsion of the vehicle 10 consistent with such factors as operator request for acceleration and conditions of the road surface 13.

Consistent with the above, arbitration of the torque split between the first and second sets of wheels 14, 32 is accomplished via regulating the torque output of at least one of the engine 12 and the second motor-generator 30, i.e., output torque T1 and/or output torque T2, in order to control the yaw rate of the vehicle 10. In order to accomplish the subject arbitration of the torque split between the first and second sets of wheels 14, 32, the controller 34 may be configured to start the engine 12 for controlling the slip of the vehicle 10 relative to the road surface 13 when the vehicle is being driven solely by the second motor-generator 30 while the engine is off Such a situation may arise, if, for example, the vehicle 10 is experiencing excess oversteer and drive torque from the engine 12 would be useful for restoring desired dynamic balance to the attitude of the vehicle.

The vehicle may also include a first electronic limited slip differential (eLSD) 50 arranged at the first set of wheels 14 and operatively connected to the engine, and a second eLSD 52 arranged at the second sets of wheels 14, 32 and operatively connected to the second motor-generator 30. The first eLSD 50 will then be configured to apportion the drive torque between the left-side wheel 14-1 and right-side wheel 14-2 of the first set of wheels 14. Similarly, the second eLSD 52 will then be configured to apportion the drive torque between the left-side wheel 32-1 and right-side wheel 32-2 of the second set of wheels 32. The controller 34 may additionally be configured to regulate the eLSD's 50, 52 to vary the torque outputs T1 and T2 of the engine 10 and second motor-generator 30 between the respective left-side wheels 14-1, 32-1 and the right-side wheels 14-2, 32-2 to control the yaw rate of the vehicle 10.

In order to regulate the eLSD's 50, 52 and vary the torque outputs T1 and T2, the controller 34 may also determine a reference rotating speed 53 of each of the wheels 14-1, 14-2, 32-1, and 32-2 relative to the road surface, i.e., a theoretical wheel speed corresponding to the determined road speed of the vehicle 10. The controller 34 may then determine slip of each of the wheels 14-1, 14-2, 32-1, and 32-2 relative to the road surface 13 based on the difference between the determined reference rotating speed 53 and the actual rotating speed of each of the wheels 14-1, 14-2, 32-1, and 32-2. Accordingly, the controller 34 may be configured to arbitrate the appropriate torque split not only between the first and second sets of wheels 14, 32, but also between the individual wheels 14-1, 14-2, 32-1, and 32-2 to thereby control the yaw rate of the vehicle 10.

Additionally, the controller 34 may be programmed with a look-up table 54 having predetermined values for the steering wheel angle, the yaw rate, the difference between the rotating speeds of each of the first and second sets of wheels 14, 32, and the speed of the vehicle 10. The values for the steering wheel angle, the yaw rate, the difference between the rotating speeds of each of the first and second sets of wheels 14, 32, and the speed of the vehicle 10 programmed into the controller 34 may be established empirically, i.e., through appropriate testing under controlled conditions. Accordingly, the controller 34 may control the slip of the vehicle 10 relative to the road surface 13 in a feed-forward or predictive control loop via comparing the determined steering wheel angle, yaw rate, and a difference between the rotating speeds of each of the first and second sets of wheels 14, 32 and the speed of the vehicle with predetermined respective values in the look-up table 54 and correspondingly regulating the torque outputs T1, T2 of the engine 12, the second motor-generator 30 and the first and second eLSD's 50, 52.

The controller 34 may be configured to control the slip of the vehicle 10 relative to the road surface 13 in a feed-back or closed loop via determining an amount or severity of wheel spin at each of the first and second sets of wheels 14, 32. To determine the severity of the wheel spin, the controller 34 may compare and determine the difference between the rotating speed of each of the left-side wheels 14-1, 32-1 and the right-side wheels 14-2, 32-2 of the first and second sets of wheels 14, 32 with the speed of the vehicle 10. Furthermore, the controller 34 may regulate the torque output T1 of the engine 12 and the second motor-generator 12, as well as at the first and second eLSD's 50, 52, to control the severity of wheel spin at the respective first and second sets of wheels 14, 32.

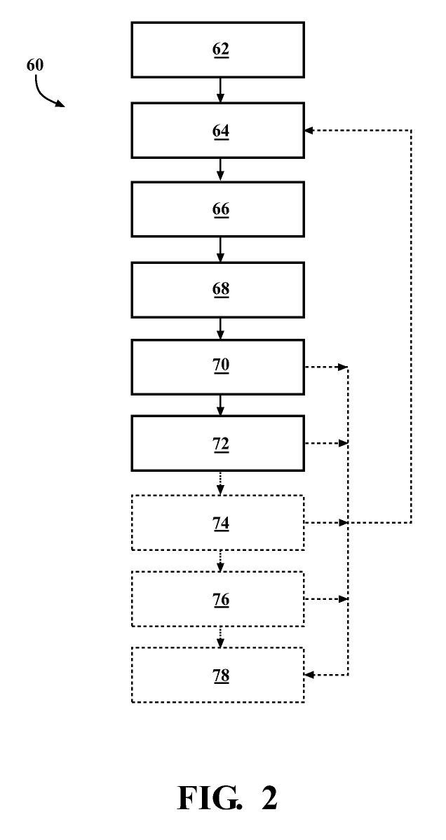

FIG. 2 depicts a method 60 of controlling operation of the vehicle 10 having independent power-sources, as described above with respect to FIG. 1. Method 60 commences in frame 62 with driving the vehicle 10 via at least one of the first power-source, i.e., the engine 10, through the first set of wheels 14 and via the second power-source, i.e., the second motor-generator 30, through the second set of wheels 32, and then proceeds to frame 64. In frame 64, the method includes determining a rotating speed of each of the first and second sets of wheels 14, 32 relative to the road surface 13. Following frame 64, the method advances to frame 66, where the method includes determining the speed of the vehicle 10 relative to the road surface 13. After the speed of the vehicle 10 is determined in frame 66, the method proceeds to frame 68, where the method includes determining the longitudinal acceleration of the vehicle.

Following frame 68, the method proceeds to frame 70 where the method includes determining the slip of the vehicle 10 relative to the road surface 13 using the determined rotating speed of each of the first and second sets of wheels 14, 32 and the speed of the vehicle, as described above. After frame 70, the method advances to frame 72, where the method includes controlling the slip of the vehicle 10 relative to the road surface 13 via regulating the torque output of the at least one of the engine 10 and the second motor-generator 30. Following frame 72, the method may proceed to frame 74, where it can include determining the steering wheel angle via the wheel angle sensor 44 and the yaw rate of the vehicle via the yaw rate sensor 48 in order to control the slip of the vehicle 10 relative to the road surface 13.

After frame 74, the method may proceed to frame 76. In frame 76 the method may include regulating at least one of the first and second eLSD's 50, 52 to vary the torque output T1 of the engine 12 and/or the second motor-generator 30 between the first-side and second-side drive wheels 14-1, 14-2, 32-1, 32-2 to control the yaw rate of the vehicle 10. The method may also include arbitrating the torque split between the first and second sets of wheels 14, 32 and among the first-side and second-side drive wheels 14-1, 14-2, 32-1, 32-2 to thereby control the yaw rate of the vehicle 10. Additionally, following any of the frames 70-76 the method may advance to frame 78. In frame 78, the vehicle 10 is initially being driven solely by the second motor-generator 30 while the engine 12 is off, and then a flying start of the engine 12 is accomplished for controlling the slip of the vehicle relative to the road surface 13. Following any of the frames 70, 72, 74, 76, and 78 the method may loop back to frame 64 for determining the rotating speed of each of the first and second sets of wheels 14, 32 relative to the road surface 13.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A method of controlling operation of an all-wheel-drive vehicle having independent power-sources, the method comprising:
driving the vehicle relative to a road surface via at least one of a first power-source operatively connected to a first set of wheels and a second power-source operatively connected to a second set of wheels;
determining a rotating speed of each of the first and second sets of wheels relative to the road surface;
determining a speed of the vehicle relative to the road surface;
determining a longitudinal acceleration of the vehicle;
determining a slip of the vehicle relative to the road surface using the determined rotating speed of each of the first and second sets of wheels and the speed of the vehicle; and
controlling the slip of the vehicle relative to the road surface via regulating a torque output of at least one of the first power-source and the second power-source.

2. The method of claim 1, wherein the vehicle includes a steering wheel configured to control a direction of the vehicle via an input of a steering wheel angle, further comprising determining the steering wheel angle and a yaw rate of the vehicle, and wherein said controlling the slip of the vehicle relative to the road surface includes using the determined steering wheel angle and yaw rate to control the yaw rate of the vehicle.

3. The method of claim 2, wherein each of the first and second sets of wheels includes a first-side drive wheel and a second-side drive wheel for transmitting the drive torque to the road surface, and wherein said determining the rotating speed of each of the first and second sets of wheels relative to the road surface includes determining the rotating speed of each respective drive wheel.

4. The method of claim 3, wherein the vehicle includes an electronic limited slip differential (eLSD) operatively connected to one of the first power-source and the second power-source and configured to apportion the drive torque between the first-side and second-side drive wheels, the method further comprising regulating the eLSD to vary the torque output of the at least one of the first power-source and the second power-source between the first-side and second-side drive wheels to control the yaw rate of the vehicle.

5. The method of claim 4, wherein each of said regulating the torque output of the at least one of the first power-source and the second power-source and regulating the eLSD is accomplished via a controller.

6. The method of claim 5, wherein said regulating the torque output of the at least one of the first power-source and the second power-source includes arbitrating a torque split between the first and second sets of wheels via the controller to thereby control the yaw rate of the vehicle.

7. The method of claim 5, wherein said controlling the slip of the vehicle relative to the road surface is accomplished in a feed-forward loop via comparing the determined steering wheel angle, yaw rate, and a difference between the rotating speeds of each of the first and second sets of wheels and the speed of the vehicle with predetermined respective values for the steering wheel angle, the yaw rate, the difference between the rotating speeds of each of the first and second sets of wheels, and the speed of the vehicle in a look-up table programmed into the controller.

8. The method of claim 5, wherein said controlling the slip of the vehicle relative to the road surface is accomplished in a feed-back loop via determining an amount of wheel spin at each of the first and second sets of wheels and regulating the torque output of the first power-source and the second power-source to control the amount of wheel spin at the respective first and second sets of wheels.

9. The method of claim 5, wherein said determining the speed of the vehicle relative to the road surface includes receiving, via the controller from a satellite, a signal indicative of the speed of the vehicle.

10. The method of claim 1, further comprising driving the vehicle solely by the second power-source while the first power-source is off and starting the first power-source for controlling the slip of the vehicle relative to the road surface.

11. A system for controlling operation of a vehicle having independent power-sources, the system comprising:
a first power-source operatively connected to a first set of wheels;
a second power-source operatively connected to a second set of wheels; and
a controller configured to regulate operation of each of the first power-source and the second power-source and programmed to:
determine a rotating speed of each of the first and second sets of wheels relative to a road surface when the vehicle is being driven via at least one of the first power-source and the second power-source;
determine a speed of the vehicle relative to the road surface;
determine a longitudinal acceleration of the vehicle;
determine a slip of the vehicle relative to the road surface using the determined rotating speed of each of the first and second sets of wheels and the speed of the vehicle; and
control the slip of the vehicle relative to the road surface by arbitrating a torque split between the first and second sets of wheels via regulating a torque output of at least one of the first power-source and the second power-source.

12. The system of claim 11, further comprising a steering wheel configured to control a direction of the vehicle via a steering wheel angle, a steering wheel angle sensor, and a yaw rate sensor, wherein the controller is additionally configured to determine the steering wheel angle and a yaw rate of the vehicle via communication with the respective steering wheel angle and yaw rate sensors and use the determined steering wheel angle and yaw rate to control the yaw rate of the vehicle.

13. The system of claim 12, wherein each of the first and second sets of wheels includes a first-side drive wheel and a second-side drive wheel for transmitting the drive torque to the road surface, and wherein the controller determines the rotating speed of each of the first and second sets of wheels relative to the road surface via determining the rotating speed of each respective drive wheel.

14. The system of claim 13, further comprising an electronic limited slip differential (eLSD) operatively connected to one of the first power-source and the second power-source and configured to apportion the drive torque between the first-side and second-side drive wheels, and the controller is additionally configured to regulate the eLSD to vary the torque output of the at least one of the first power-source and the second power-source between the first-side and second-side drive wheels to control the yaw rate of the vehicle.

15. The system of claim 11, wherein the controller is additionally configured to arbitrate a torque split between the first and second sets of wheels to thereby control the yaw rate of the vehicle.

16. The system of claim 12, wherein the controller is programmed with a look-up table having predetermined values for the steering wheel angle, the yaw rate, the difference between the rotating speeds of each of the first and second sets of wheels, and the speed of the vehicle, and the controller controls the slip of the vehicle relative to the road surface in a feed-forward loop via comparing the determined steering wheel angle, yaw rate, and a difference between the rotating speeds of each of the first and second sets of wheels and the speed of the vehicle with predetermined respective values in the look-up table.

17. The system of claim 11, wherein the controller is configured to control the slip of the vehicle relative to the road surface in a feed-back loop via determining an amount of wheel spin at each of the first and second sets of wheels and regulating the torque output of the first power-source and the second power-source to control the amount of wheel spin at the respective first and second sets of wheels.

18. The system of claim 11, wherein said determining the speed of the vehicle relative to the road surface includes receiving, via the controller from a satellite, a signal indicative of the speed of the vehicle.

19. The system of claim 11, wherein the controller is additionally configured to start the first power-source for controlling the slip of the vehicle relative to the road surface when the vehicle is being driven solely by the second power-source while the first power-source is off.

20. The system of claim 11, further comprising an energy storage device configured to supply energy to the second power-source, and wherein the controller is additionally configured to phase out the second power-source when the energy supplied to the second second power-source by the energy storage device is below a predetermined value.
